(19) United States
(12) Patent Application Publication
(10) Pub. No.: US 2022/0131266 A1
(43) Pub. Date: Apr. 28, 2022

(54) Null-Steering Phased Array Antenna

(71) Applicant: AVX Antenna, Inc. d/b/a Ethertronics, Inc., San Diego, CA (US)

(72) Inventors: Abhishek Singh, San Diego, CA (US); Sebastian Rowson, San Diego, CA (US)

(21) Appl. No.: 17/508,268

(22) Filed: Oct. 22, 2021

Related U.S. Application Data
(60) Provisional application No. 63/104,756, filed on Oct. 23, 2020.

(51) Int. Cl. H01Q 3/36; H01Q 25/04; H01Q 9/16

(52) U.S. Cl. CPC H01Q 3/36; H01Q 9/16; H01Q 25/04

(57) ABSTRACT

A phased array antenna is provided. The phased array antenna includes an array of antenna cells disposed on a substrate. Each of the antenna cells is configured to communicate on a frequency band ranging from 24 gigahertz (GHz) to 52 GHz. Furthermore, one or more of the antenna cells includes a multi-mode antenna configurable in a plurality of antenna modes. Each of the antenna modes has a distinct radiation pattern. When the multi-mode antenna is configured in a first antenna mode of the plurality of antenna modes, the phased array antenna has a first radiation pattern. Conversely, the phased array antenna has a second radiation pattern that is different than the first radiation pattern when the multi-mode antenna is configured in a second antenna mode of the plurality of antenna modes.

### PRIORITY CLAIM

The present application claims the benefit of priority of U.S. Provisional App. No. 63/104,756, titled “Null-Steering Phased Array Antenna” and having a filing date of Oct. 23, 2020, which is incorporated by reference herein.

### FIELD

The present disclosure relates generally to phased array antennas. More particularly, the present disclosure relates to a null-steering phased array antenna.

### BACKGROUND

Antenna systems configured for millimeter-wave communications (e.g., 5^{th} generation mobile communications) can include a phase shifter circuit and a phased array antenna electrically coupled to the phase shifter circuit. The phase shifter circuit can alter a phase of a RF signal received from a RF source such that a phase of the RF signal measured at an output of the RF phase shifter circuit is different relative to a phase of the RF signal measured at an input of the RF phase shifter circuit. In this manner, the RF phase shifter circuit can control a phase shift of the RF signal to steer a radiation pattern associated with the phased array antenna.

### SUMMARY

Aspects and advantages of embodiments of the present disclosure will be set forth in part in the following description, or may be learned from the description, or may be learned through practice of the embodiments.

In one aspect, a phased array antenna is provided. The phased array antenna includes an array of antenna cells disposed on a substrate. Each of the antenna cells is configured to communicate on a frequency band ranging from 24 Gigahertz (GHz) to 52 GHz. Furthermore, one or more of the antenna cells includes a multi-mode antenna configurable in a plurality of antenna modes. Each of the antenna modes has a distinct radiation pattern. When the multi-mode antenna is configured in a first antenna mode of the plurality of antenna modes, the phased array antenna has a first radiation pattern. Conversely, the phased array antenna has a second radiation pattern that is different than the first radiation pattern when the multi-mode antenna is configured in a second antenna mode of the plurality of antenna modes.

In some implementations, one or more nulls associated with the first radiation pattern are pointed in a first direction and one or more nulls associated with the second radiation pattern are pointed in a second direction that is different than the first direction.

In some implementations, the multi-mode antenna includes a driven element and a parasitic element. The parasitic element can be offset relative to the driven element. Furthermore, in some implementations, the driven element includes an isolated magnetic dipole. In some implementations, the isolated magnetic dipole includes a first portion and a second portion. The first portion extends from a circuit board such that the first portion is substantially perpendicular to the circuit board. The second portion extends from the first portion such that the second portion is substantially perpendicular to the first portion. Furthermore, the second portion defines a slot.

In some implementations, a scan range of the phased array antenna in an azimuth plane is wider than a scan range of the phased array antenna in an elevation plane. For instance, in some implementations, the scan range in the azimuth plane is about 120 degrees, whereas the scan range in the elevation plane is about 30 degrees.

In some implementations, each of the antenna cells includes a multi-mode antenna. In alternative implementations, one or more of the antenna cells includes an antenna having a fixed radiation pattern.

In another aspect, an antenna system is provided. The antenna system includes a phase shifter circuit electrically coupled to a radio frequency source. The antenna system includes a phased array antenna electrically coupled to the phase shifter circuit. The phased array antenna includes an array of antenna cells disposed on a substrate. Each of the antenna cells is configured to communicate on a frequency band ranging from 24 Gigahertz (GHz) to 52 GHz. Furthermore, one or more of the antenna cells includes a multi-mode antenna configurable in a plurality of antenna modes. Each of the antenna modes has a distinct radiation pattern. When the multi-mode antenna is configured in a first antenna mode of the plurality of antenna modes, the phased array antenna has a first radiation pattern. Conversely, the phased array antenna has a second radiation pattern that is different than the first radiation pattern when the multi-mode antenna is configured in a second antenna mode of the plurality of antenna modes.

In yet another aspect, a method of controlling operation of an antenna system that includes a phase shifter circuit and a phased array antenna includes configuring each of a plurality of multi-mode antennas of the phased array antenna in one of a plurality of antenna modes to generate a radiation pattern associated with the phased array antenna, each of the antenna modes having a distinct radiation pattern. The method further includes controlling the plurality of multi-mode antennas to steer the radiation pattern associated with the phased array antenna along at least one of an azimuth plane or an elevation plane.

In some implementations, controlling the plurality of multi-mode antennas to steer the radiation pattern includes controlling the plurality of multi-mode antennas to steer one or more nulls associated with the radiation pattern.

In some implementations, the method further includes controlling the phase shifter circuit to steer the radiation pattern associated with the phased array antenna along at least one of the azimuth plane or the elevation plane.

In some implementations, configuring each of the plurality of multi-mode antennas includes configuring a first group of the multi-mode antennas in a first antenna mode of the plurality of antenna modes and configuring a second group of the multi-mode antennas in a second antenna mode of the plurality of antenna modes.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of components of an antenna system according to example embodiments of the present disclosure.

FIG. 2 depicts a phased array antenna according to example embodiments of the present disclosure.

FIG. 3 depicts a radiation pattern associated with a phased array antenna according to example embodiments of the present disclosure.

FIG. 4 depicts a multi-mode antenna according to example embodiments of the present disclosure.

FIG. 5 depicts radiation patterns of a multi-mode antenna of a phased array antenna in an azimuth plane according to example embodiments of the present disclosure.

FIG. 6 depicts radiation pattern of a multi-mode antenna of a phased array antenna in an elevation plane according to example embodiments of the present disclosure.

FIG. 7 depicts a flow diagram of a method of controlling an antenna system having a phased array antenna according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Phased array antennas can include a plurality of antenna cells. Each of the plurality of antenna cells can be electrically coupled to a phase shifter circuit. The phase shifter circuit can be configured to control a phase shift associated with a RF signal provided to the phased array antenna. By controlling the phase shift associated with the RF signal, a radiation pattern associated with the phased array antenna can be steered without physically moving one or more of the antenna cells. However, characteristics (e.g., gain of side lobes, gain of grating lobes) of the radiation pattern of the phased array antenna can vary as the phase shift circuit steers the radiation pattern. These variations in characteristics of the radiation pattern can affect performance of the phased array antenna in wideband applications (e.g., millimeter wave communications).

Example aspects of the present disclosure are directed to a null-steering phased array antenna. The phased array antenna can include an array of antenna cells disposed on a substrate. Each of the antenna cells can be configured to communicate over a frequency band associated with millimeter wave communications. For instance, the frequency band can range from about 24 GHz to about 52 GHz. Details of the antenna cells will now be discussed in more detail.

One or more of the antenna cells can include a multi-modal antenna configurable in a plurality of antenna modes. Each of the antenna modes can have a distinct radiation pattern. The multi-mode antenna can include a driven element (e.g., isolated magnetic dipole) and a parasitic element. The parasitic element can be offset relative to the driven element. In some implementations, each of the antenna cells can include the multi-mode antenna. In alternative implementations, one or more of the antenna cells can include an antenna having a fixed radiation pattern.

The one or more multi-mode antennas can be configured in one of the plurality of antenna modes to generate a plurality of radiation patterns for the phased array antenna. For instance, the one or more multi-mode antennas can each be configured in a first antenna mode of the plurality of antenna modes to generate a first radiation pattern for the phased array antenna. Conversely, the one or more multi-mode antennas can each be configured in a second antenna mode of the plurality of antenna modes to generate a second radiation pattern for the phased array antenna. In some implementations, a first group of multi-modal antennas can be configured in the first antenna mode and a second group of multi-mode antennas can be configured in the second antenna mode to generate a third radiation pattern for the phased array antenna.

The one or more multi-mode antennas can be controlled to steer the radiation pattern (e.g., first radiation pattern, second radiation pattern, third radiation pattern, etc.) along at least one of an azimuth plane or an elevation plane. In some implementations, the one or more multi-mode antennas can be controlled to steer one or more nulls associated with the radiation pattern of the phased array antenna. It should be understood that one or more nulls associated with the first radiation pattern of the phased array antenna can be steered in a different direction than one or more nulls associated with other radiation patterns (e.g., second radiation pattern, third radiation pattern, etc.) of the phased array antenna.

The phased array antenna according to the present disclosure can provide numerous technical effects and benefits. For instance, the one or more multi-mode antennas of the phased array antenna can be controlled to generate multiple radiation patterns (e.g., first radiation pattern, second radiation pattern, etc.) for the phased array antenna. Furthermore, the one or more multi-mode antennas can be controlled to steer the radiation pattern along at least one of the azimuth plane or the elevation plane. For instance, the one or more multi-mode antennas can be controlled to steer one or more nulls associated with the radiation pattern along at least one of the azimuth plane or the elevation plane. Furthermore, the multi-mode antennas can be configured in one of the plurality of antenna modes as needed to achieve a desired effect (e.g., side-lobe suppression, grating lobe suppression) on the radiation pattern associated with the phased array antenna.

As used herein, the use of the term “about” in conjunction with a numerical value is intended to refer to within 20% of the stated amount. In addition, the terms “first” and “second” may be used interchangeably to distinguish one component from another and are not intended to signify location or importance of the individual components.

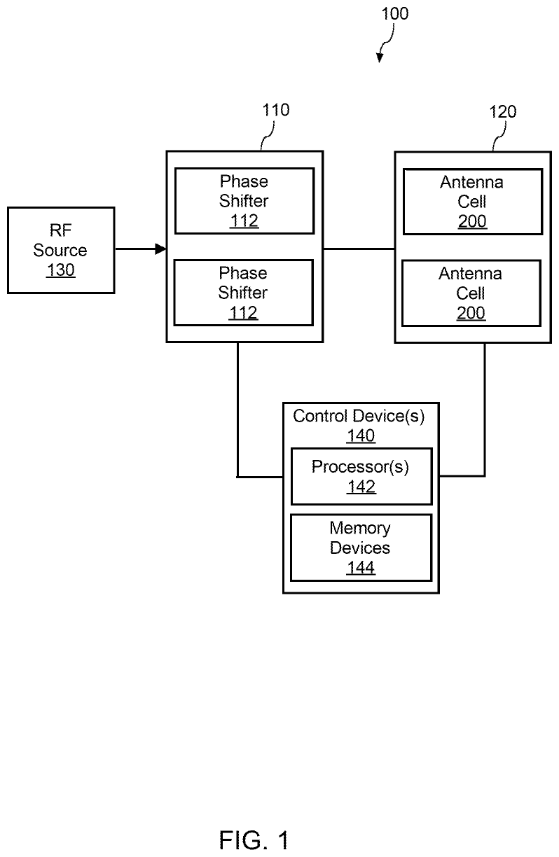

Referring now to the FIGS., FIG. 1 depicts an antenna system 100 according to example embodiments of the present disclosure. As shown, the antenna system 100 can include a RF phase shifter circuit 110 and a phased array antenna 120. The RF phase shifter circuit 110 can include a plurality of phase shifters 112. Each of the phase shifters 112 can be electrically coupled to a RF source 130. In this manner, each of the phase shifters 112 can receive a RF signal from the RF source 130. In some implementations, the RF signal can be associated with millimeter wave communications (e.g., about 24 GHz to about 52 GHz). It should be understood that each of the phase shifters 112 can be configured to control a phase shift of the RF signal received from the RF source 130. In this manner, the radiation pattern of RF waves emitted via the phased array antenna 120 can be steered without physically moving one or more antenna cells 200 of the phased array antenna 120.

The antenna system 100 can include one or more control devices 140. The one or more control devices 140 can be communicatively coupled to the phased array antenna 120. In this manner, the one or more control devices 140 can be configured to control an array of antenna cells 200 of the phased array antenna 120 to steer a radiation pattern associated with the phased array antenna 120 along at least one of an azimuth plane or an elevation plane. As will be discussed below in more detail, the one or more control devices 140 can control the array of antenna cells 200 to steer one or more nulls associated with the radiation pattern along at least one of the azimuth plane or the elevation plane.

Furthermore, in some implementations, the one or more control devices 140 can be communicatively coupled to the RF phase shifter circuit 110. In this manner, the one or more control devices 140 can be configured to control the phase shifters 112 thereof to steer the radiation pattern of the phased array antenna 120 along at least one of the azimuth plane or the elevation plane.

As shown, the one or more control devices 140 can include one or more processors 132 and one or more memory devices 144. The one or more processors 142 can include any suitable processing device, such as a microprocessor, microcontroller, integrated circuit, logic device, or other suitable processing device. The one or more memory devices 144 can include one or more computer-readable media, including, but not limited to, non-transitory computer-readable media, RAM, ROM, hard drives, flash drives, or other memory devices.

The one or more memory devices 144 can store information accessible by the one or more processors 142, including computer-readable instructions that can be executed by the one or more processors 142. The computer-readable instructions can be any set of instructions that, when executed by the one or more processors 142, cause the one or more processors 142 to perform operations. The computer-readable instructions can be software written in any suitable programming language or may be implemented in hardware. In some implementations, the computer-readable instructions can be executed by the one or more processors to cause the one or more processors to perform operations, such as controlling the antenna cells 200 of the phased array antenna 120. Additionally, the operations can include controlling one or more phase shifters 112 of the RF phase shifter circuit 110.

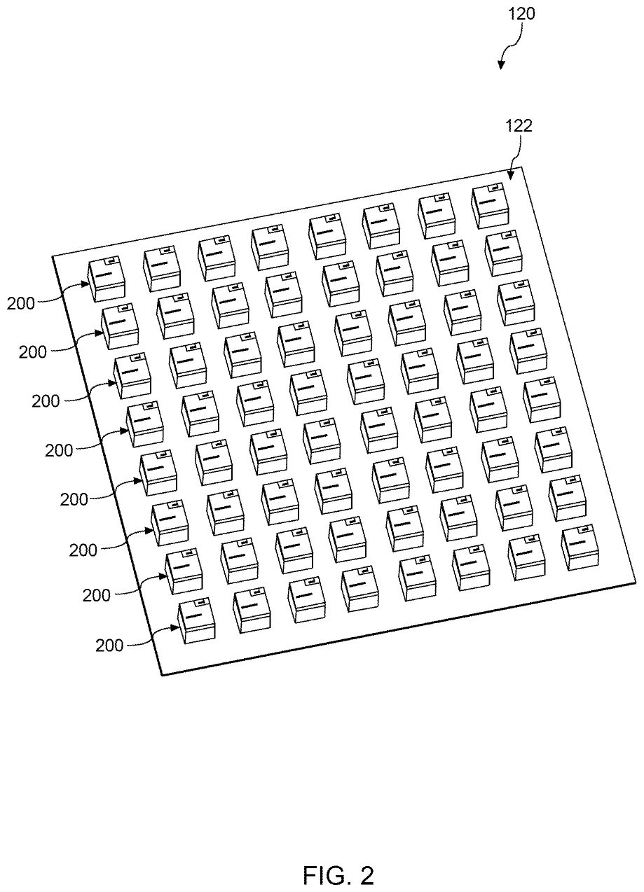

Referring now to FIG. 2, the array of antenna cells 200 can disposed on a substrate 122. For instance, in some implementations, the array of antenna cells 200 can include 64 individual antenna cells 200. In alternative implementations, the array of antenna cells 200 can include more or fewer antenna cells 200. As shown, in some implementations, the antenna cells 200 can be arranged on the substrate 122 in a grid configuration (e.g., row-column). Furthermore, in such implementations, the antenna cells 200 can be spaced apart from one another by a distance (e.g., λ/2).

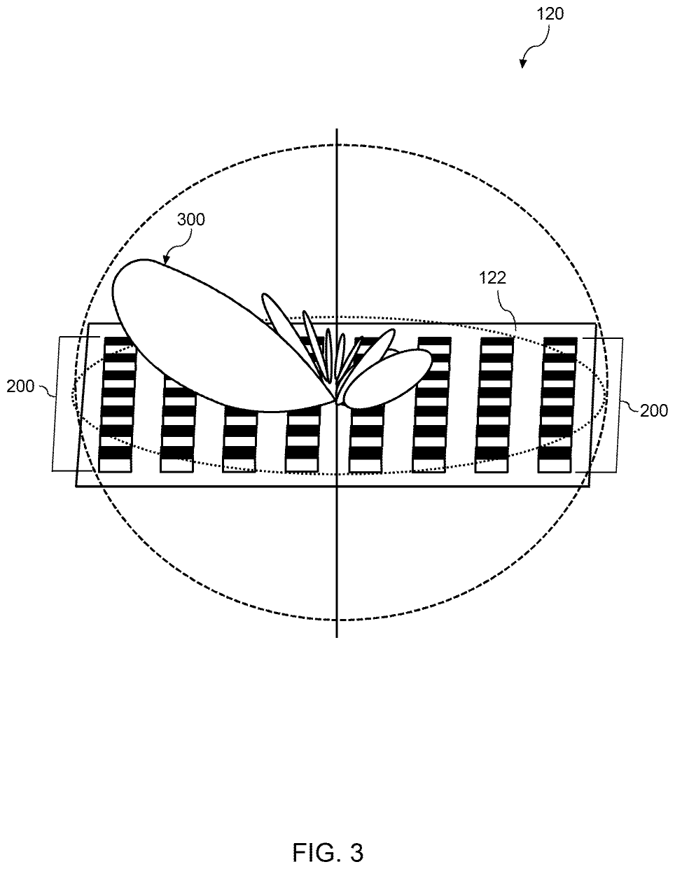

FIG. 3 depicts a radiation pattern 300 associated with a phased array antenna 120 according to example embodiments of the present disclosure. The RF phase shifter circuit 110 (shown in FIG. 1) can control a phase shift of the RF signal the RF source 130 (shown in FIG. 1) provides to the phased array antenna 120. In this manner, the radiation pattern 300 can be steered in one or more directions without physically moving one or more of the antenna cells 200 of the phased array antenna 120. For instance, the phase shift of the RF signal can be controlled to steer the radiation pattern 300 along a first plane (e.g., azimuth plane). Alternatively, or additionally, the phase shift of the RF signal can be controlled to steer the radiation pattern 300 along a second plane (e.g., elevation plane) that is substantially perpendicular (e.g., within about 10 degrees, within about 5 degrees, within about 1 degree, etc.) to the first plane. In some implementations, a scan range of the phased array antenna 120 in an azimuth plane can be wider than a scan range of the phased array antenna 120 in an elevation plane. For instance, the scan range of the phased array antenna 120 in the azimuth plane can be about 120 degrees, whereas the scan range of the phased array antenna 120 in the elevation plane can be about 30 degrees.

One or more of the antenna cells 200 of the phased array antenna 120 can include a multi-mode antenna configurable in a plurality of antenna modes. Each of the antenna modes can have a distinct radiation pattern. In some implementations, each of the antenna cells 200 can include the multi-mode antenna. In alternative implementations, one or more of the antenna cells can include an antenna having a fixed radiation pattern.

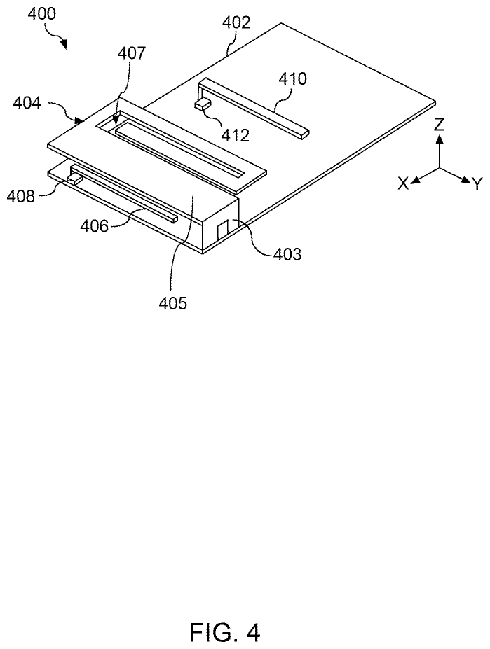

FIG. 4 illustrates an example multi-mode antenna 400 according to the present disclosure. The multi-mode antenna 400 can define a horizontal axis X, a transverse axis Y, and a vertical axis Z. As shown, the multi-mode antenna 400 can include a circuit board 402 (e.g., including a ground plane) and a driven element 404 disposed on the circuit board 402. In some implementations, the driven element 404 can include an isolated magnetic dipole.

In some implementations, the driven element 404 (e.g., isolated magnetic dipole) can include a first portion 403 that extends from the circuit board 402 such that the first portion 403 of the isolated magnetic dipole is substantially perpendicular (less than a 15 degree, less than a 10 degree, less than a 5 degree, less than a 1 degree, etc. difference from 90 degrees.) relative to the circuit board 402. The driven element 404 can further include a second portion 405 that extends from the first portion 403 thereof. For instance, in some implementations, the second portion 405 can extend from the first portion 403 such that the second portion 405 is substantially perpendicular (e.g., about 10 degrees, about 5 degrees, etc.) to the first portion 403. In this manner, the second portion 405 of the driven element 404 can be spaced apart from the circuit board 402 along the vertical axis Z. In some implementations, the second portion 405 can define a slot 407. For instance, in some implementations, the slot 407 can have a U-shape. It should be understood, however, that the slot 407 can have any suitable shape.

An antenna volume may be defined between the circuit board 402 (e.g., and the ground plane) and the driven element 404. The multi-mode antenna 400 can include a first parasitic element 406 positioned at least partially within the antenna volume. The multi-mode antenna 400 can further include a first tuning element 408 coupled with the first parasitic element 406. The first tuning element 408 can be a passive or active component or series of components and can be configured to alter a reactance on the first parasitic element 406 either by way of a variable reactance or shorting to ground. It should be appreciated that altering the reactance of the first parasitic element 406 can result in a frequency shift of the multi-mode antenna 400. It should also be appreciated that the first tuning element 408 can include at least one of a tunable capacitor, MEMS device, tunable inductor, switch, a tunable phase shifter, a field-effect transistor, or a diode.

In some implementations, the multi-mode antenna 400 can include a second parasitic element 410 disposed adjacent the driven element 404 and outside of the antenna volume. The multi-mode antenna 400 can further include a second tuning element 412. In some implementations, the second tuning element 412 can be a passive or active component or series of components and may be configured to alter a reactance on the second parasitic element 410 by way of a variable reactance or shorting to ground. It should be appreciated that altering the reactance of the second parasitic element 410 result in a frequency shift of the multi-mode antenna 400. It should also be appreciated that the second tuning element 412 can include at least one of a tunable capacitor, MEMS device, tunable inductor, switch, a tunable phase shifter, a field-effect transistor, or a diode.

In example embodiments, operation of at least one of the first tuning element 408 and the second tuning element 412 can be controlled to adjust (e.g., shift) the antenna radiation pattern of the driven element 404. For example, a reactance of at least one of the first tuning element 408 and the second tuning element 412 can be controlled to adjust the antenna radiation pattern of the driven element 404. Adjusting the antenna radiation pattern can be referred to as “beam steering”. However, in instances where the antenna radiation pattern includes a null, a similar operation, commonly referred to as “null steering”, can be performed to shift the null to an alternative position about the driven element 404 (e.g., to reduce interference).

FIG. 4 depicts one example modal antenna having a plurality of antenna modes for purposes of illustration and discussion. Those of ordinary skill in the art, using the disclosures provided herein, will understand that other modal antennas and/or antenna configurations can be used without deviating from the scope of the present disclosure. As used herein a “modal antenna” refers to an antenna capable of operating in a plurality of antenna modes where each antenna mode is associated with a distinct radiation pattern.

When the multi-mode antennas 400 included in the array of antenna cells 200 (FIG. 2) are configured in a first antenna mode of the plurality of antenna modes, the phased array antenna 120 can have a first radiation pattern. Conversely, the phased array antenna 120 can have a second radiation pattern when the multi-mode antennas 400 included in the array of antenna cells 200 (FIG. 2) are configured in a second antenna mode of the plurality of antenna modes. The second radiation pattern can be different than the first radiation pattern. In this manner, the multi-modal antennas 400 included in the array of antenna cells 200 can be controlled to generate multiple radiation patterns (e.g., first radiation pattern, second radiation pattern etc.) for the phased array antenna 120.

Furthermore, the multi-mode antennas 400 included in the array of antenna cells 200 can be controlled to steer the radiation pattern of the phased array antenna 120 along at least one of the azimuth plane or the elevation plane. For instance, the multi-mode antennas 400 can be controlled to steer one or more nulls associated with the radiation pattern of the phased array antenna 120 along at least one of the azimuth plane or the elevation plane. In this manner, steering capability of the phased array antenna 120 can be improved. Furthermore, different combinations of the multi-mode antennas 400 included in the array of antenna cells 200 can be controlled to achieve a desired effect (e.g., side-lobe suppression, grating lobe suppression) on the radiation pattern of the phased array antenna 120.

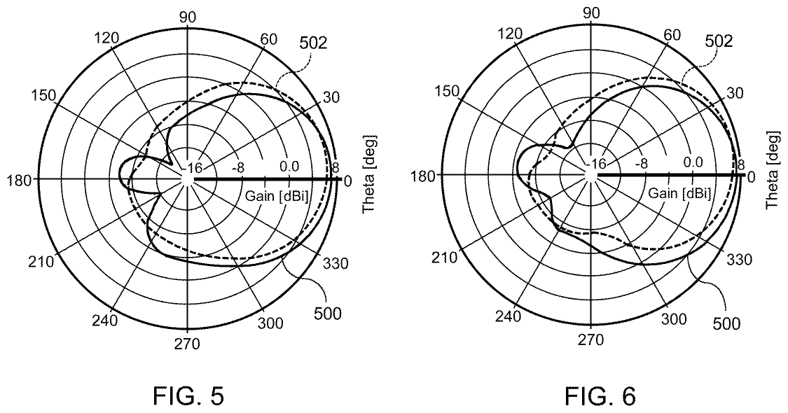

Referring now to FIGS. 5 and 6, a graphical representation of different radiation patterns of a multi-mode antenna are provided according to example embodiments of the present disclosure. FIG. 5 depicts a first radiation pattern 500 and a second radiation pattern 502 of a multi-mode antenna in an azimuth plane according to example embodiments of the present disclosure. FIG. 6 depicts the first radiation pattern 500 and the second radiation pattern 502 of the multi-mode antenna in an elevation plane according to example embodiments of the present disclosure. As shown, the second radiation pattern 502 can be different than the first radiation pattern 500. For instance, a shape of one or more lobes of the second radiation pattern 502 can be different than a shape of one or more lobes of the first radiation pattern 500. Alternatively, or additionally, a gain associated with one or more lobes of the second radiation pattern 502 can be different (e.g., larger, less) than a gain associated with one or more lobes of the first radiation pattern 500.

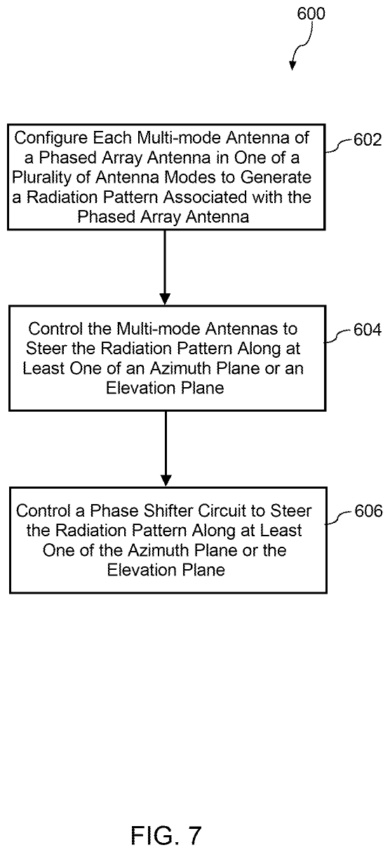

Referring now to FIG. 7, a flow diagram of a method 600 for controlling operation of an antenna system having a phased array antenna that includes a plurality of multi-mode antennas is provided according to example embodiments of the present disclosure. In general, the method 800 will be discussed herein with reference to the antenna system 100 described above with reference to FIG. 1. In addition, although FIG. 7 depicts steps performed in a particular order for purposes of illustration and discussion, the method discussed herein is not limited to any particular order or arrangement. One skilled in the art, using the disclosure provided herein, will appreciate that various steps of the method disclosed herein can be omitted, rearranged, combined, and/or adapted in various ways without deviating from the scope of the present disclosure.

At (602), the method 600 can include configuring each multi-mode antenna of the phased array antenna in one of the plurality of antenna modes to generate a radiation pattern associated with the phased array antenna. For instance, configuring the multi-mode antennas can include controlling a first group of the multi-mode antennas to operate in a first antenna mode of the plurality of antenna modes. Additionally, configuring the multi-mode antennas can include controlling a second group of the multi-mode antennas to operate in a second antenna mode of the plurality of antenna modes. It should be understood that the multi-mode antennas in the first group are different from the multi-mode antennas in the second group.

At (604), the method 600 can include controlling the plurality of multi-mode antennas to steer the radiation pattern generated at (602) along at least one of an azimuth plane or an elevation plane. For instance, in some implementations, the multi-mode antennas can be controlled to steer one or more nulls associated with the radiation pattern along at least one of the azimuth plane or the elevation plane.

At (606), the method 600 can include controlling, by the one or more control devices, the phase shifter circuit to steer the radiation pattern generated at (602) along at least one of the azimuth plane or the elevation plane. In some implementations, controlling the phase shifter circuit can include providing one or more control signals to the phase shifter circuit associated with controlling one or more phase shifters thereof. For instance, the one or more control signals can be associated with applying a phase shift to the RF signal provided to one or more antenna cells (e.g., multi-mode antenna) of the phased array antenna to steer the radiation pattern along at least one of the azimuth plane or the elevation plane.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A phased array antenna comprising:
an array of antenna cells disposed on a substrate, each of the antenna cells configured to communicate on a frequency band ranging from 24 GHz to 52 GHz, one or more of the antenna cells comprising a multi-mode antenna configurable in a plurality of antenna modes, each of the antenna modes having a distinct radiation pattern,
wherein when the multi-mode antenna is configured in a first antenna mode of the plurality of antenna modes, the phased array antenna has a first radiation pattern, and
wherein when the multi-mode antenna is configured in a second antenna mode of the plurality of antenna modes, the phased array antenna has a second radiation pattern, the second radiation pattern being different than the first radiation pattern.

2. The phased array antenna of claim 1, wherein:
one or more nulls associated with the first radiation pattern are pointed in a first direction; and
one or more nulls associated with the second radiation pattern are pointed in a second direction that is different than the first direction.

3. The phased array antenna of claim 1, wherein the multi-mode antenna comprises:
a driven element; and
a parasitic element that is offset relative to the driven element.

4. The phased array antenna of claim 3, wherein the driven element comprises an isolated magnetic dipole.

5. The phased array antenna of claim 4, wherein the isolated magnetic dipole includes a first portion and a second portion, the first portion extending from a circuit board such that the first portion is substantially perpendicular to the circuit board, the second portion extending from the first portion such that the second portion is substantially perpendicular to the first portion, the second portion defining a slot.

6. The phased array antenna of claim 1, wherein a scan range of the phased array antenna in an azimuth plane is wider than a scan range of the phased array antenna in an elevation plane.

7. The phased array antenna of claim 6, wherein:
the scan range in the azimuth plane is about 120 degrees; and
the scan range in the elevation plane is about 30 degrees.

8. The phased array antenna of claim 1, wherein each of the antenna cells comprises the multi-mode antenna.

9. The phased array antenna of claim 1, wherein one or more of the antenna cells comprise an antenna having a fixed radiation pattern.

10. An antenna system comprising:
a phase shifter circuit electrically coupled to a radio frequency (RF) source; and
a phased array antenna electrically coupled to the phase shifter circuit, the phased array antenna comprising an array of antenna cells disposed on a substrate, each of the antenna cells configured to communicate on a frequency band ranging from 24 GHz to 52 GHz, one or more of the antenna cells comprising a multi-mode antenna configurable in a plurality of antenna modes, each of the antenna modes having a distinct radiation pattern,
wherein when the multi-mode antenna is configured in a first antenna mode of the plurality of antenna modes, the phased array antenna has a first radiation pattern, and
wherein when the multi-mode antenna is configured in a second antenna mode of the plurality of antenna modes, the phased array antenna has a second radiation pattern, the second radiation pattern being different than the first radiation pattern.

11. The antenna system of claim 10, wherein:
one or more nulls associated with the first radiation pattern are pointed in a first direction; and
one or more nulls associated with the second radiation pattern are pointed in a second direction that is different than the first direction.

12. The antenna system of claim 10, wherein the multi-mode antenna comprises:
a driven element; and
a parasitic element that is offset relative to the driven element.

13. The antenna system of claim 12, wherein the driven element comprises an isolated magnetic dipole.

14. The antenna system of claim 10, wherein a scan range of the phased array antenna in an azimuth plane is wider than a scan range of the phased array antenna in an elevation plane.

15. The antenna system of claim 10, wherein each of the antenna cells comprises the multi-mode antenna.

16. The antenna system of claim 10, wherein one or more of the antenna cells comprise an antenna having a fixed radiation pattern.

17. A method of controlling operation of an antenna system comprising a phase shifter circuit and a phased array antenna, the method comprising:
configuring, by one or more control devices, each of a plurality of multi-mode antennas of the phased array antenna in one of a plurality of antenna modes to generate a radiation pattern associated with the phased array antenna, each of the antenna modes having a distinct radiation pattern; and
controlling, by the one or more control devices, the plurality of multi-mode antennas to steer the radiation pattern associated with the phased array antenna along at least one of an azimuth plane or an elevation plane.

18. The method of claim 17, wherein controlling the plurality of multi-mode antennas to steer the radiation pattern comprises controlling, by the one or more control devices, the plurality of multi-mode antennas to steer one or more nulls associated with the radiation pattern.

19. The method of claim 17, further comprising:
controlling, by the one or more control devices, the phase shifter circuit to steer the radiation pattern associated with the phased array antenna along at least one of the azimuth plane or the elevation plane.

20. The method of claim 17, wherein configuring each of the plurality of multi-mode antennas comprises:
configuring a first group of the multi-mode antennas in a first antenna mode of the plurality of antenna modes; and
configuring a second group of the multi-mode antennas in a second antenna mode of the plurality of antenna modes.
